(19) United States
(12) Patent Application Publication
(10) Pub. No.: US 2024/0053472 A1
(43) Pub. Date: Feb. 15, 2024

(54) PROXIMITY SENSOR

(71) Applicant: ams International AG, Jona (CH)

(72) Inventors: Vijay Yadgiri ELE, Hyderabad (IN); Sandeep VERNEKAR, Hyderabad (IN); Dinesh KURUGANTI, Guntur (IN); Radhika KODE, Hyderabad (IN)

(21) Appl. No.: 18/267,366

(22) PCT Filed: Dec. 14, 2021
(86) PCT No.: PCT/EP2021/085674

§ 371 Date: Jun. 14, 2023

(30) Foreign Application Priority Data
Dec. 15, 2020 (IN) 202041054513

(51) Int. Cl. G01S 17/04; G01J 1/42; G01S 7/497

(52) U.S. Cl. CPC G01S 17/04; G01J 1/4204; G01S 7/497; G01S 7/51

(57) ABSTRACT

A proximity sensing device is disclosed comprising: a radiation emitter; a radiation sensor configured to sense a reflected radiation from the radiation emitter; a memory for storing a plurality of ambient radiation level ranges and a plurality of coefficients that map onto the plurality of ambient radiation level ranges; and processing circuitry configured to compensate an output from the radiation sensor for crosstalk by subtracting from the output a measured ambient radiation level scaled by either: a coefficient selected from the plurality of coefficients; or a value derived from the plurality of coefficients. A proximity sensing method and a proximity sensing calibration method are also disclosed.

### TECHNICAL FIELD OF THE DISCLOSURE

The present disclosure relates to a proximity sensor or proximity sensing device operable to detect a target in the environment of the proximity sensing device, and particularly relates to a method of compensating the proximity sensing device for crosstalk.

### BACKGROUND

A proximity sensing device is used to detect, within an environment of the proximity sensing device, if a target exists and/or is used to measure a distance between the target and the proximity sensing device. The proximity sensing device comprises an infrared (IR) LED transmitter and a photodiode configured to detect light reflected from the target. The amount of current produced by the photodiode is proportional to the distance between the target and the proximity sensing device. The IR LED transmitter is operable to produce a particular number of light pulses, while an integrator integrates each resultant pulse current produced by the photodiode, to produce a digital output current.

Ideally, when there is no target present within an environment of the proximity sensing device to reflect light from the target, the digital current output should be zero. However, if the proximity sensing device is underneath a surface, such as underneath a mobile phone display glass, a portion of the light emitted by the IR LED transmitter may be reflected by the surface, which may result in an unwanted non-zero digital current output. The unwanted non-zero digital current output is referred to as crosstalk.

The crosstalk is compensated for in the integrator by means of a calibration process. The calibration process involves measuring the crosstalk to obtain a calibration current. In measurements subsequent to the calibration process, the calibration current is subtracted from the digital current output, which results in a desired digital current output, e.g. a digital current output without the effect of the unwanted crosstalk.

The calibration current is subtracted from the digital current output using a digital to analogue converter, which is controlled using a digital signal. A single value of the digital signal is stored in storage, e.g. in a programmable offset register.

It is an aim of at least one aspect of the present disclosure to provide an alternative and more accurate approach to reducing crosstalk.

### SUMMARY

The Applicants have found that using a single digital signal value may be unsuitable to provide compensation across a range of ambient IR light intensities. In particular, a single digital signal value may result in unwanted non-zero digital current outputs, e.g. inaccurate proximity measurements, across at least some of the range of ambient IR light intensities.

The present disclosure therefore aims to provide a proximity sensing device and method for compensating for crosstalk across a range of ambient IR light intensities.

According to a first aspect of the disclosure, there is provided a proximity sensing device comprising: a radiation emitter; a radiation sensor configured to sense a reflected radiation from the radiation emitter; and a memory for storing a plurality of ambient radiation level ranges and a plurality of coefficients that map onto the plurality of ambient radiation level ranges. The proximity sensing device further comprises processing circuitry configured to compensate an output from the radiation sensor for crosstalk by subtracting from the output a measured ambient radiation level scaled by either: a coefficient selected from the plurality of coefficients, or a value derived from the plurality of coefficients.

Advantageously, such a device may be suitable to more accurately compensate the output from the radiation sensor for crosstalk across a range of ambient radiation levels. Each ambient radiation level may have a different ambient radiation amplitude or intensity. Crosstalk may refer to unwanted ambient radiation reflected from surfaces of the proximity sensing device or a device that the proximity sensing device is a constituent part of. For example, crosstalk may result from a mobile phone display glass.

In particular, the proximity sensing device may be suitable to prevent an error, which results from the crosstalk, increasing or otherwise varying in relation to an intensity of the ambient radiation.

Advantageously, such a device may be suitable for operation in high-crosstalk applications.

Notably, the proximity sensing device is configured to use a suitable one of many possible coefficients to scale the output on the basis of the prevailing ambient radiation level so as to produce a more accurate output than in the prior art, which assumes a single constant value is sufficient.

Advantageously, such a device may be suitable for operation in a presence of strong ambient radiation.

The proximity sensing device comprise an ambient radiation sensor configured to obtain the measured ambient radiation level.

The processing circuitry of the proximity sensing device may be configured to select the coefficient from the plurality of coefficients using at least one of steps (a)-(c):
(a) comparing the measured ambient radiation level to the ambient radiation level ranges;
(b) selecting the ambient radiation level range that the measured ambient radiation level is within or closest to;
(c) selecting the coefficient from the plurality of coefficients that maps onto the ambient radiation level range that the measured ambient radiation level is within or closest to.

Advantageously, selecting the ambient radiation level range that the measured ambient radiation level is within may be performed if the ambient radiation levels are continuous.

Advantageously, selecting the ambient radiation level range that the measured ambient radiation level is closest to may be performed if the ambient radiation levels are discontinuous. For example, if some ambient radiation level data is missing.

Advantageously, a combination of continuous and non-continuous ambient radiation levels may be used.

The processing circuitry of the proximity sensing device may be configured to derive the value by performing on the plurality of coefficients at least one of: linear interpolation, second or higher order interpolation, curve fitting, or a machine learning algorithm.

Advantageously, linear interpolation may increase an accuracy of deriving the value relative to the prior art. Linear interpolation may enable the use of simpler and/or cheaper processing circuitry relative to other deriving methods. Linear interpolation may refer to interpolating first order polynomial functions.

Advantageously, second or higher order interpolation may increase the accuracy of deriving the value relative to linear interpolation. Second or higher order may refer to interpolating polynomial functions of at least a second order. For example, second, third, fourth, or fifth order polynomial functions may be used.

Advantageously, curve fitting may be used when a function other than a polynomial function best fits ambient radiation level data to increase the accuracy of deriving the value relative to the other value deriving methods. Curve fitting may refer to the interpolation of any non-polynomial function, including but not limited to: exponentials, logarithms, and trigonometric functions.

Advantageously, a machine learning algorithm may be used to derive the value, for example, the machine learning algorithm may be used if the ambient radiation level data is continually updated and/or changes over time such that a pre-defined function would not always optimally fit the ambient radiation level data.

Instead of interpolation, extrapolation may be used to derive the value.

Advantageously, deriving the value may be performed by any of the value deriving methods alone or in combination. For example, different methods to derive the value may be used for different ambient radiation levels.

The radiation may be one of microwave radiation, millimetre wavelength radiation, infrared light, visible light, or ultraviolet light.

Advantageously, the radiation may be infrared light (e.g. sunlight or incandescent light).

The radiation sensor of the proximity sensing device may include an optical filter that is configured to only transmit a wavelength of the reflected radiation, e.g. the radiation emitted by the radiation emitter, into the radiation sensor.

Advantageously, the optical filter may be a notch filter.

The proximity sensing device may be configured to normalize the measured ambient radiation level for an integration time of the ambient radiation sensor. The integration time of the ambient radiation sensor may be approximately 10 ms, 100 ms, 1000 ms, 10000 ms.

Advantageously, normalizing the measured ambient radiation level may enable ambient radiation levels to be more easily used to compensate the output from the radiation sensor for crosstalk.

Advantageously, the integration time may be varied based on the ambient radiation level. For example, for a high ambient radiation level, a low integration time may be used and vice versa.

The proximity sensing device may be configured to normalize the measured ambient radiation level for an analogue gain of the ambient radiation sensor.

Advantageously, normalizing the analogue gain may enable ambient radiation levels to be more easily used to compensate the output from the radiation sensor for crosstalk.

Advantageously, the analogue gain may be programmable. For example, the analogue gain may be programmable to a 2 times, 4 times, or 8 times gain value. The analogue gain may also be higher, e.g. in a range of 1 to 8192 times or 1 to 50,000 times.

According to a second aspect of the disclosure, there is provided a proximity sensing method comprising: receiving an output of a radiation sensor, wherein the radiation sensor is configured to sense a reflected radiation from a radiation emitter; and receiving a measured ambient radiation level. The proximity sensing method further comprises retrieving from a memory containing a plurality of ambient radiation level ranges and a plurality of coefficients that map onto the plurality of ambient radiation level ranges, a coefficient selected from the plurality of coefficients; or a value derived from the plurality of coefficients based on the measured ambient radiation level. The proximity sensing method further comprises compensating the output for crosstalk by subtracting from the output the measured ambient radiation level scaled by either the coefficient selected from the plurality of coefficients or the value derived from the plurality of coefficients.

Advantageously, such a method may be suitable to more accurately compensate the output from the radiation sensor for crosstalk across a range of ambient radiation levels.

In particular, such a method may be suitable to prevent an error, which results from the crosstalk, increasing in relation to an intensity of the ambient radiation.

Advantageously, such a method may be suitable for operation in high-crosstalk applications.

Advantageously, such a method may be suitable for operation in a presence of high ambient radiation.

The proximity sensing method may comprise obtaining the measured ambient radiation level using an ambient radiation sensor.

The proximity sensing method may comprise selecting the coefficient from the plurality of coefficients using at least one of steps (a)-(c):
(a) comparing the measured ambient radiation level to the ambient radiation level ranges;
(b) selecting the ambient radiation level range that the measured ambient radiation level is within or closest to;
(c) selecting the coefficient from the plurality of coefficients that maps onto the ambient radiation level range that the measured ambient radiation level is within or closest to.

Advantageously, selecting the ambient radiation level range that the measured ambient radiation level is within may be performed if the ambient radiation levels are continuous.

Advantageously, selecting the ambient radiation level range that the measured ambient radiation level is closest to may be performed if the ambient radiation levels are discontinuous. For example, if some ambient radiation level data is missing.

Advantageously, a combination of continuous and non-continuous ambient radiation levels may be used.

The proximity sensing method may comprise deriving the value by performing on the plurality of coefficients at least one of: linear interpolation, second or higher order interpolation, curve fitting, or a machine learning algorithm.

Advantageously, linear interpolation may increase an accuracy of deriving the value relative to the prior art. Linear interpolation may enable the use of simpler and/or cheaper processing circuitry relative to other deriving methods. Linear interpolation may refer to interpolating first order polynomial functions.

Advantageously, second or higher order interpolation may increase the accuracy of deriving the value relative to linear interpolation. Second or higher order may refer to interpolating polynomial functions of at least a second order. For example, second, third, fourth, or fifth order polynomial functions may be used.

Advantageously, curve fitting may be used when a function other than a polynomial function best fits the ambient radiation level data to increase the accuracy of deriving the value relative to the other value deriving methods. Curve fitting may refer to the interpolation of any non-polynomial function, including but not limited to: exponentials, logarithms, and trigonometric functions.

Advantageously, a machine learning algorithm may be used to derive the value, for example, the machine learning algorithm may be used if the ambient radiation level data is continually updated and/or changes over time such that a pre-defined function would not optimally fit the ambient radiation level data.

Instead of interpolation, extrapolation may be used to derive the value.

Advantageously, deriving the value may be performed by any of the value deriving methods alone or in combination. For example, different methods to derive the value may be used for different ambient radiation levels.

The radiation may be one of microwave radiation, millimetre wavelength radiation, infrared light, visible light, or ultraviolet light.

Advantageously, the radiation may be infrared light (e.g. sunlight or incandescent light).

The proximity sensing method may comprise normalizing the measured ambient radiation level for an integration time of the ambient radiation sensor. The integration time of the ambient radiation sensor may be approximately 10 ms, 100 ms, 1000 ms, 10000 ms.

Advantageously, normalizing the measured ambient radiation level may enable ambient radiation levels to be more easily used to compensate the output from the radiation sensor for crosstalk.

Advantageously, the integration time may be varied based on the ambient radiation level. For example, for a high ambient radiation level, a low integration time may be used and vice versa.

The proximity sensing method may comprise normalizing the measured ambient radiation level for an analogue gain of the ambient radiation sensor.

Advantageously, normalizing the analogue gain may enable ambient radiation levels to be more easily used to compensate the output from the radiation sensor for crosstalk.

Advantageously, the analogue gain may be programmable. For example, the analogue gain may be programmable to a 2 times, 4 times, or 8 times gain value. The analogue gain may also be higher, e.g. in a range of 1 to 8192 times or 1 to 50,000 times.

According to a third aspect of the disclosure, there is provided a proximity sensing calibration method for determining a plurality of coefficients for use in compensating an output from a radiation sensor for crosstalk, the method comprising: receiving a plurality of outputs from the radiation sensor, wherein the radiation sensor is configured to sense a reflected radiation from a radiation emitter; receiving a plurality of ambient radiation levels, each of which is measured at a time that substantially corresponds to a time of measurement of each of the plurality of outputs; and determining a relationship between the plurality of outputs and the corresponding plurality of ambient radiation levels and deriving the plurality of coefficients based on the relationship.

Measuring each of the plurality of ambient radiation levels at substantially the same time as measuring each of the plurality of outputs may not require that a measurement rate or time of the ambient radiation level and the output is identical. For example, the ambient radiation level may be measured every 100 ms and the output may be measured every 50 ms. In some embodiments, the time of measurement of the ambient radiation level may be offset from the time of measurement of the output.

Advantageously, the ambient radiation level may be measured within a time interval threshold of the output. For example, the threshold may be 10 ms, 100 ms, 1 s, 10 s.

Advantageously, the proximity sensing calibration method may compensate for ageing of the proximity sensing device.

Advantageously, the proximity sensing calibration method may be performed by a user or a manufacturer of the proximity sensing device. For example, the proximity sensing calibration method may be performed when the device is first manufactured and/or may be performed by a user either before or during use.

The proximity sensing calibration method may be invoked on receipt of a calibration instruction (e.g. from a user) or may be invoked automatically, for example, periodically.

In some embodiments, the proximity sensing calibration method may be invoked when a parameter is determined to fall outside of an acceptable range. For example, this could be when some or all of the plurality of coefficients no longer result in accurate compensation of the proximity sensing device for crosstalk.

Determining the relationship in the proximity sensing calibration method may comprise using any one of: a linear fit of the plurality of outputs at the corresponding ambient radiation levels, a second or higher order fit of the plurality of outputs at the corresponding ambient radiation levels, a curve fit of the plurality of outputs at the corresponding ambient radiation levels, or a machine learning algorithm.

Advantageously, linear interpolation may increase an accuracy of determining the relationship relative to the single value of the prior art. Linear interpolation may enable the use of simpler and/or cheaper processing circuitry relative to other deriving methods. Linear interpolation may refer to interpolating first order polynomial functions.

Advantageously, second or higher order interpolation may increase the accuracy of determining the relationship relative to linear interpolation. Second or higher order may refer to interpolating polynomial functions of at least a second order. For example, second, third, fourth, or fifth order polynomial functions may be used.

Advantageously, curve fitting may be used when a function other than a polynomial function best fits proximity sensing calibration data to increase the accuracy of determining the relationship relative to the other relationship determining methods. Curve fitting may refer to the interpolation of any non-polynomial function, including but not limited to: exponentials, logarithms, and trigonometric functions.

Advantageously, a machine learning algorithm may be used to determine the relationship, for example, the machine learning algorithm may be used if proximity sensing calibration data is continually updated and/or changes over time such that a pre-defined function would not always optimally fit the proximity sensing calibration data.

Instead of interpolation, extrapolation may be used to determine the relationship between the plurality of outputs and the corresponding plurality of ambient radiation levels.

Advantageously, determining the relationship may be performed by any of the relationship determining methods alone or in combination. For example, different methods to determining the relationship may be used for different ambient radiation levels.

The plurality of coefficients in the proximity sensing calibration method may be based on the relationship of the plurality of outputs and the plurality of corresponding ambient radiation levels.

The plurality of coefficients used in the proximity sensing method may be updated by performing the proximity sensing calibration method.

According to a fourth aspect of the disclosure, there is provided a non-transitory computer readable storage medium comprising instructions which, when executed by processing circuitry cause the processing circuitry to perform the proximity sensing method.

According to a fifth aspect of the disclosure, there is provided a non-transitory computer readable storage medium comprising instructions which, when executed by processing circuitry cause the processing circuitry to perform the proximity sensing calibration method.

Advantageously, the computer readable storage medium of the fourth and fifth aspects of the disclosure may be the same computer readable storage medium.

Advantageously, the processing circuitry of the fourth and fifth aspects of the disclosure may be the same processing circuitry.

Advantageously, the non-transitory computer readable storage medium may automatically execute the proximity sensing calibration method. For example, the proximity sensing calibration method may be executed every year, month, week, day, hour, minute, second, or millisecond.

Advantageously, the proximity sensing calibration method may notify a user once a calibration accuracy threshold has been exceeded. For example, once the plurality of coefficients no longer result in accurate compensation of the proximity sensing device for crosstalk. In which case, the user may be prompted to invoke the proximity sensing calibration method.

Advantageously, the proximity sensing device may be incorporated beneath a display screen for example, of a smartphone, a tablet, a laptop or other computer.

Advantageously, the proximity sensing device may be incorporated into a cellular device.

Advantageously, the processing circuitry configured to carry out the proximity sensing method and/or the proximity sensing calibration method may be incorporated into a cellular device.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure might be used, either alone or in combination with any other defined feature, in any other aspect or embodiment or to form a further aspect or embodiment of the disclosure.

### BRIEF DESCRIPTION OF THE PREFERRED EMBODIMENTS

These and other aspects of the present disclosure will now be described, by way of example only, with reference to the accompanying drawings, wherein:

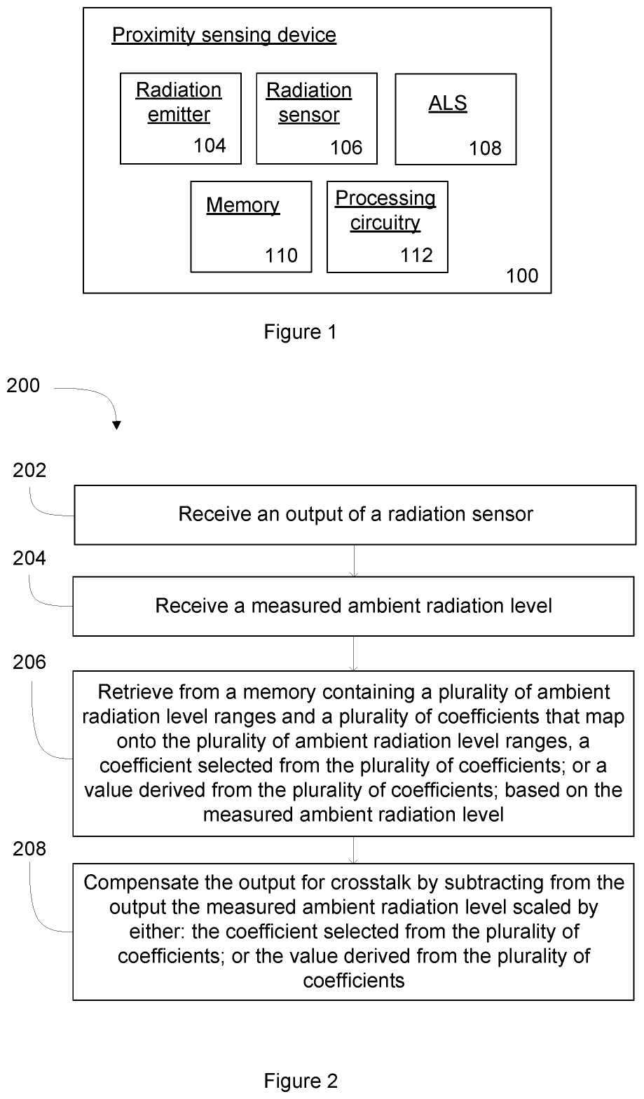

FIG. 1 depicts a block diagram of a proximity sensing device, according to an embodiment of the disclosure;

FIG. 2 depicts a flow-chart of a proximity sensing method, according to an embodiment of the disclosure;

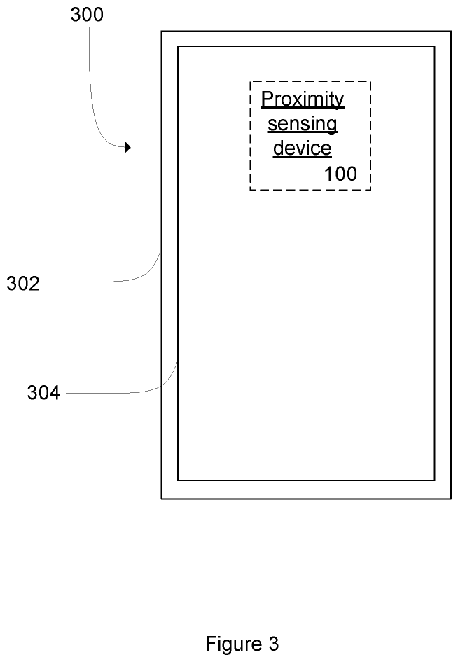

FIG. 3 depicts the proximity sensing device underneath a display of a cellular device;

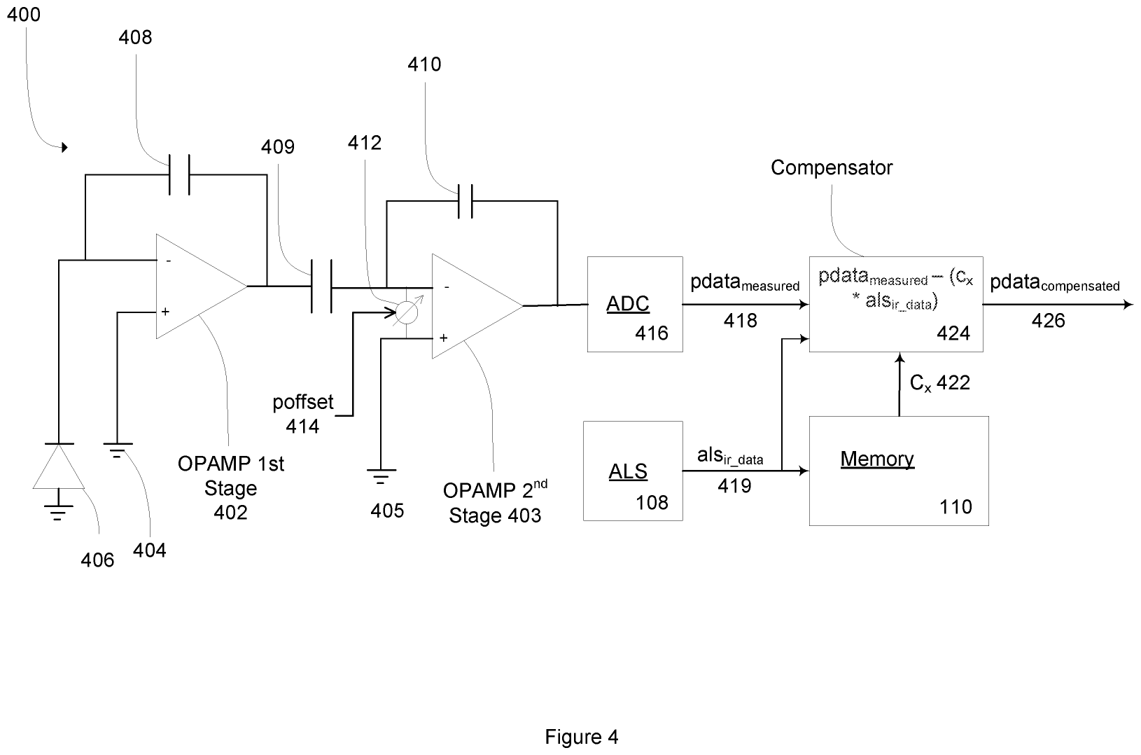

FIG. 4 depicts a circuit diagram of sensing and processing components of the proximity sensing device of FIG. 1;

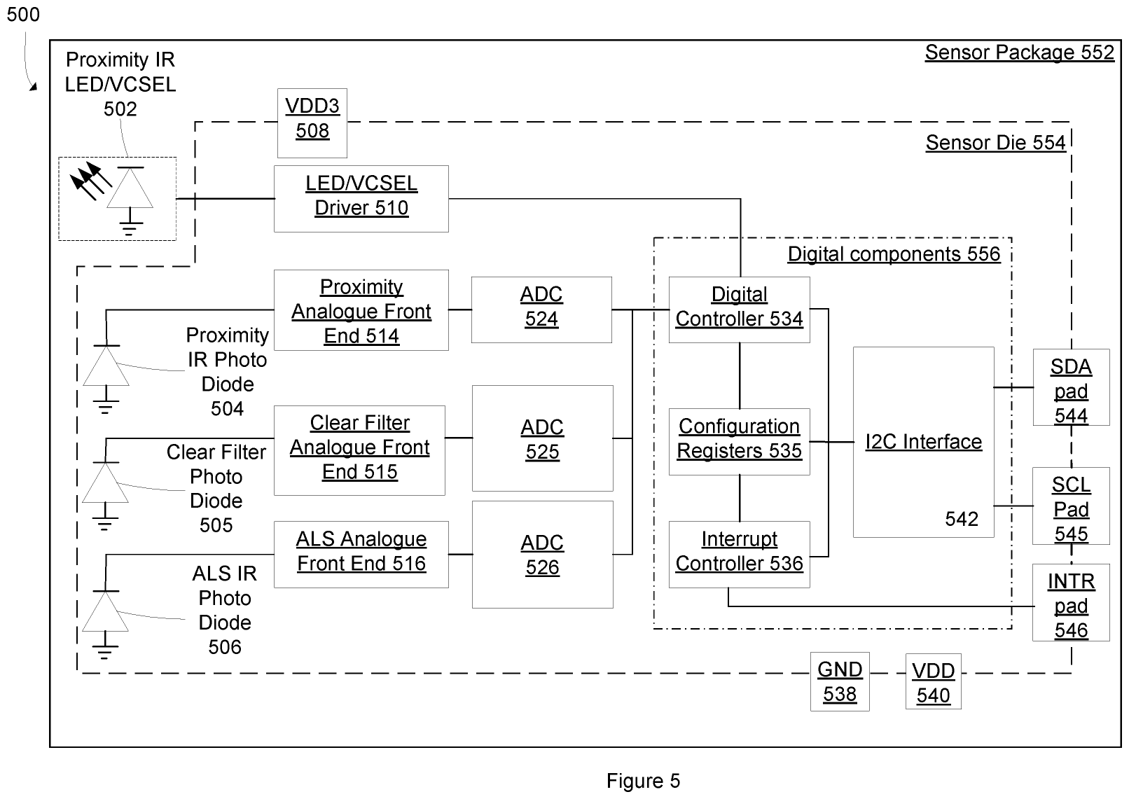

FIG. 5 depicts a schematic diagram of the proximity sensing device of FIG. 1;

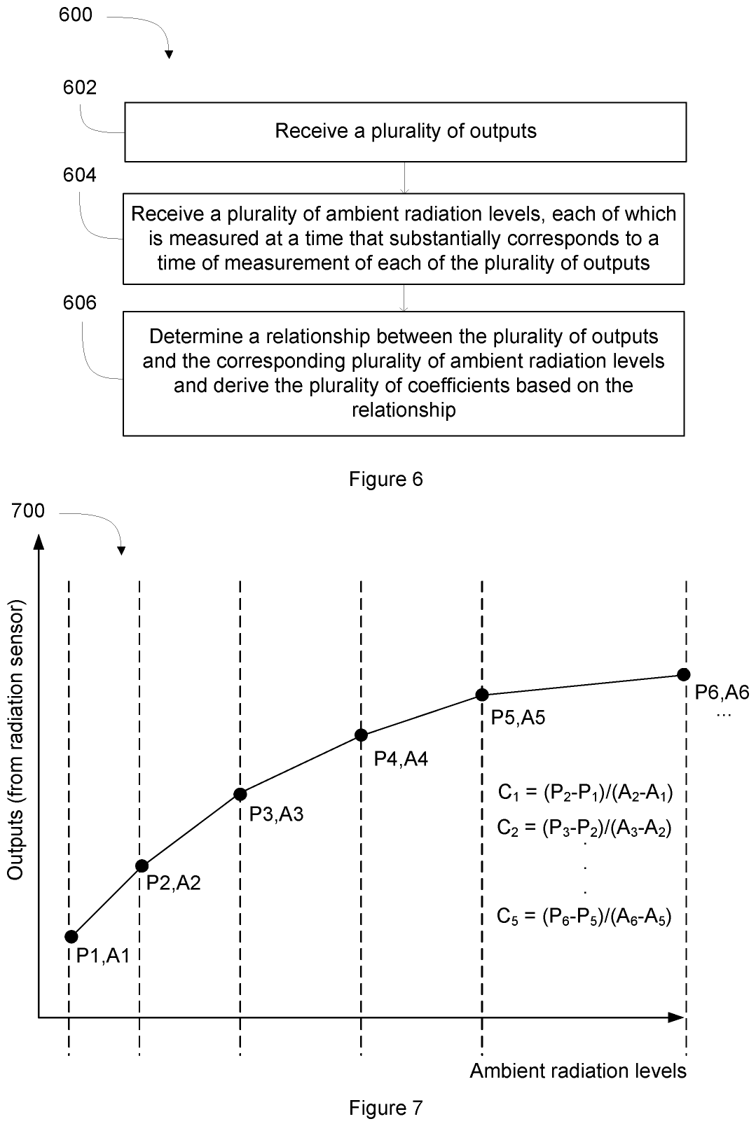

FIG. 6 depicts a flow-chart of a proximity sensing calibration method, according to an embodiment of the disclosure; and

FIG. 7 depicts an example plot of a plurality of outputs against a plurality of ambient radiation levels.

### DETAILED DESCRIPTION OF THE PREFERRED EMBODIMENTS

FIG. 1 depicts a block diagram of a proximity sensing device 100, according to an embodiment of the disclosure. The device 100 comprises: a radiation emitter 104, a radiation sensor 106, an ambient light sensor (ALS) 108, a memory 110, and processing circuitry 112.

The radiation emitter 104 is operable to emit IR radiation. The radiation emitter 104 may be an IR light emitting diode (LED), vertical cavity surface emitting laser (VCSEL) or the like.

The radiation sensor 106 is configured to sense a reflected radiation from the radiation emitter 104. For example, the emitted radiation may be reflected from a target such as a person. The radiation sensor 106 may comprise at least one photodiode or the like.

The ALS 108 is operable to measure an ambient radiation level. The ALS 108 may comprise at least one photodiode or the like. In some embodiments, the ALS 108 may be absent from the proximity sensing device 100. For example, the ambient radiation level may be measured using the radiation sensor 106. More specifically, the radiation sensor 106 may measure the ambient radiation level when the radiation emitter 104 is not emitting (or at least when no reflected radiation from the radiation emitter 104 is expected). In some embodiments, the ALS 108 may be provided as a separate component outside of the proximity sensing device 100. In which case, the ALS 108 may be communicatively coupled to the proximity sensing device 100 (by a wired or wireless connection) to transmit measured ambient radiation level data to the proximity sensing device 100. Thus, the proximity sensing device 100 may be configured to obtain or receive measured ambient radiation levels from an external ALS 108. The memory 110 is operable to store a plurality of ambient radiation level ranges and a plurality of coefficients that map onto the plurality of ambient radiation level ranges. The memory 110 may be a PROM, EPROM, EEPROM, EROM, NVRAM, FRAM, or the like.

The processing circuitry 112 is configured to compensate an output from the radiation sensor 106 for crosstalk by subtracting from the output a measured ambient radiation level scaled by either: a coefficient selected from the plurality of coefficients; or a value derived from the plurality of coefficients.

FIG. 2 depicts an example of a flow-chart 200 of a proximity sensing method, performed by the proximity sensing device 100 of FIG. 1, according to an embodiment of the disclosure.

In a first step 202, the processing circuitry 112 is configured to receive data in the form of an output of a radiation sensor 106. The output of the radiation sensor 106 corresponds to the radiation sensor 106 receiving reflected radiation from the radiation emitter 104 (e.g. after it has been reflected from a target such as a person).

In a second step 204, the processing circuitry 112 is configured to receive data in the form of a measured ambient radiation level (e.g. from the ALS 108).

After the measured ambient radiation level has been received, in a third step 206, the processing circuitry 112 is configured to retrieve data from the memory 110. The memory 110 contains a plurality of ambient radiation level ranges and a plurality of coefficients that map onto the plurality of ambient radiation level ranges. The data retrieved from the memory 110 is determined based on the measured ambient radiation level and is either: a coefficient selected from the plurality of coefficients, or a value derived from the plurality of coefficients. In particular, the coefficient or value will usually have an inverse relationship as the measured ambient radiation level increases—e.g. as the measured ambient radiation level increases, the coefficient or value will decrease.

In a fourth step 208, the processing circuitry 112 is configured to compensate the output for crosstalk by subtracting from the output the measured ambient radiation level scaled by either: the coefficient selected from the plurality of coefficients; or the value derived from the plurality of coefficients.

In some embodiments, the processing circuitry 112 is configured to directly use the coefficient in steps 206 and 208. In this case, the processing circuitry 112 is configured to select the coefficient from the plurality of coefficients by comparing the measured ambient radiation level to the ambient radiation level ranges in the memory 110. More specifically, the processing circuitry 112 selects the coefficient from the plurality of coefficients that maps onto the ambient radiation level range that the measured ambient radiation level is within or closest to.

In some embodiments, the processing circuitry 112 is configured to use a value derived from the plurality of coefficients in steps 206 and 208. In this case, the processing circuitry 112 may be configured to derive the value by performing linear interpolation using two or more of the plurality of coefficients, for example, if the measured ambient radiation level falls outside of an ambient radiation level range stored in the memory 110.

Instead of linear interpolation, second or higher order interpolation, curve fitting, or a machine learning algorithm may be used to determine a relationship between the outputs and the measured ambient radiation level.

Instead of interpolation, extrapolation may be used to determine a relationship between the outputs and the measured ambient radiation level.

The skilled person will understand that the steps 202, 204, 206, 208 may be performed in the order described above or other orders. The skilled person will also understand that some steps may be performed simultaneously or in parallel with other steps.

FIG. 3 depicts a block diagram of the proximity sensing device 100 as previously described underneath a display 304 of a cellular device 300 such as mobile phone, tablet, laptop or the like.

The cellular device 300 comprises: the proximity sensing device 102; a body 302; and the display 304. The display 304 may be an LED, organic-LED (OLED) or the like. In operation, the device emits radiation, a portion of which is reflected from the display 304 as the reflected radiation. For example, the reflected radiation may be reflected from a window that constitutes one component of the display 304.

FIG. 4 depicts a circuit diagram 400 of the sensing and processing components of the proximity sensing device of FIG. 1, according to an embodiment of the disclosure. The circuit 400 comprises: a first stage operational amplifier (OPAMP) 402; a second stage OPAMP 403; a photodiode 406; a first ground 404; a second ground 405; a first capacitor 408; a second capacitor 409; a third capacitor 410; a variable poffset voltage 414; a variable resistor 412; an ALS 108; an analogue to digital converter (ADC) 416; a memory 110; and a compensator 424.

An output of the photodiode 406 connects to a negative input of the first stage OPAMP 402 and the first ground 404 connects to a positive input of the first stage OPAMP 402. An output of the first stage OPAMP 402 is returned to the negative input of the first stage OPAMP 402 via the first capacitor 408.

The second ground 405 connects to a positive input of the second stage OPAMP 403. The output of the first stage OPAMP 402 (after the first capacitor 408 return connection) passes through the second capacitor 409 and connects to a negative input of the second stage OPAMP 403. The positive and negative inputs of the second stage OPAMP 403 are connected by the variable resistor 412. An input of the variable resistor 412 is connected to the variable poffset voltage 414. An output of the second stage OPAMP 403 is returned to the negative input of the second stage OPAMP 403 via the third capacitor 410.

The output of the second stage OPAMP 403 (after the third capacitor 410 return connection) connects to an input of the ADC 416. An output of the ADC 416, in the form of pdata_{measured} 418, is connected to an input of the compensator 424. The output of the ADC 416 is referred to elsewhere in this disclosure as “an output from the radiation sensor 106”. The variable poffset voltage 414 is operable to compensate pdata_{measured} 418 for internal reflections in an optical stack of the device.

An output of the ALS 108, in the form of ambient light data (als_{ir_data} 419), is connected to both an input of the memory 110 and an input of the compensator 424.

An output of the memory 110, in the form of a coefficient/value (Cₓ 422), is connected to an input of the compensator 424.

The compensator 424 receives the pdata_{measured} 418, Cₓ 422, and als_{ir_data} 419 inputs and outputs a compensated signal (pdata_{compensated}) 426 derived from the uncompensated output 418. Specifically, to calculate pdata_{compensated} 426, the compensator 424 subtracts from pdata_{measured} 418 a product of C, 422 and als_{ir_data} 419. Expressed differently,

pdata_{compensated}=pdata_{measured}(Cₓ*als_{ir_data})

Although not shown, the photodiode 406 has an optical filter on top that allows only the wavelength of light equal to that of the radiation emitter (not shown). A digital controller sends enable signals (pulses) to the radiation emitter while an analogue front end integrates current from the photodiode 406. A programmed number of pulses emitted by the radiation emitter may be in the range of 1-64 pulses. Each pulse contains an on phase (e.g. the emitter is on) and an off phase (e.g. the emitter is off). During the on phase, the photodiode 406 is operable to detect radiation resulting from the radiation emitter and ambient radiation. During the off phase, the photodiode 406 is operable only to detect ambient radiation. At the end of each pulse, a signal representative of only the radiation resulting from the radiation emitter may be obtained by subtracting off phase signals from on phase signals (e.g. which removes a contribution due to the ambient radiation). Each signal representative of only the radiation resulting from an individual pulse of the radiation emitter may be accumulated using the second stage (OPAMP 403) to obtain an integrated voltage. Once the programmed number of pulses are completed, the integrated voltage is converted to a digital signal using ADC 416.

However, in this embodiment, the analogue front end has two stages (e.g. OPAMP 402 and OPAMP 403). The first stage (OPAMP 402) is used to integrate the photodiode 406 current per pulse. The second stage (OPAMP 403) is used to integrate the output of the first stage (OPAMP 402). Once all the programmed pulses are completed, the output of the second stage (OPAMP 403) is converted to a digital signal and this is the output (pdata_{measured} 418) of the radiation sensor 106.

The proximity sensing method may comprise normalizing the measured ambient radiation level for an integration time of the ambient radiation sensor. The integration time of the ambient radiation sensor may be approximately 10 ms, 100 ms, 1000 ms, 10000 ms. Advantageously, normalizing the measured ambient radiation level may enable ambient radiation levels to be more easily used to compensate the output from the radiation sensor for crosstalk. The integration time may be varied based on the ambient radiation level. For example, for a high ambient radiation level, a low integration time may be used and vice versa.

The proximity sensing method may comprise normalizing the measured ambient radiation level for an analogue gain of the ambient radiation sensor. Advantageously, normalizing the analogue gain may enable ambient radiation levels to be more easily used to compensate the output from the radiation sensor for crosstalk. The analogue gain may be programmable. For example, the analogue gain may be programmable to a 2 times, 4 times, or 8 times gain value. The analogue gain may also be higher, e.g. in a range of 1 to 8192 times or 1 to 50,000 times.

FIG. 5 depicts a schematic diagram 500 of the proximity sensing device 100 of FIG. 1, according to an embodiment of the disclosure. The schematic diagram 500 comprises: a proximity IR LED/VCSEL 502; a proximity IR photo diode 504; a clear filter photo diode 505; an ALS IR photo diode 506; a supply voltage VDD3 508; LED/VCSEL driver 510; a proximity analogue front end 514; a clear filter analogue front end 515; an ALS analogue front end 516; a first ADC 524; a second ADC 525; a third ADC 526; a digital controller 534; configuration registers 535; an interrupt controller 536; an I2C interface 542; a ground (GND) 538; a supply voltage VDD 540; a serial data line SDA pad 544; a serial clock line SCL pad 545; and an interrupt (INTR) pad 546. The digital controller 534, configuration registers 535, interrupt controller 536 and I2C interface 542 are grouped together as digital components 556, which are provided on a sensor die 554 with the other components apart from the proximity IR LED/VCSEL 502, which is provided adjacent the sensor die in a sensor package 552.

The proximity IR LED/VCSEL 502 is driven by the LED/VCSEL driver 510.

An output of the proximity IR photo diode 504 is connected to an input of the proximity analogue front end 514.

An output of the clear filter photo diode 505 is connected to an input of the clear filter analogue front end 515.

An output of the ALS IR photo diode 506 is connected to an input of the ALS analogue front end 516.

An output of the proximity analogue front end 514 is connected to an input of the first ADC 524.

An output of the clear filter analogue front end 515 is connected to an input of the second ADC 525.

An output of the ALS analogue front end 516 is connected to an input of the third ADC 526.

The output of the first ADC 524, second ADC 525, and third ADC 526 are connected to an input of the digital controller 534. Additionally, the LED/VCSEL driver 510 is connected to the digital controller 534.

The digital controller 534 is connected to the configuration registers 535.

The interrupt controller 536 is connected to the configuration registers 535 and the INTR pad 546. The interrupt controller 536 may be used, for example, when a parameter exceeds a threshold indicating that calibration is required, e.g. to prompt for use of a proximity sensing calibration method as described below.

The digital controller 534, the configuration registers 535, and the interrupt controller 536 are all connected to the I2C interface 542.

The I2C interface 542 is connected to the SDA pad 544 and the SCL pad 545.

The sensor die 554 comprises the digital components 556, the VDD3 508, the proximity IR photo diode 504, the clear filter photo diode 505, the ALS IR photo diode 506, the LED/VCSEL driver 510, the proximity analogue front end 514, the clear filter analogue front end 515, the ALS analogue front end 516, the first ADC 524, the second ADC 525, the third ADC 526, the GND 538, the VDD 540, the SDA pad 544, the SCL pad 545, and the INTR pad 546.

The sensor package 552 corresponds to the proximity sensing device 100 and comprises the sensor die 554 and the proximity IR LED/VCSEL 502.

The components of the sensor package 552 operate as described above, with reference to FIGS. 2 and 4, to compensate the output from the proximity IR photo diode 504 depending on the measured ambient radiation level. In operation, the proximity IR LED/VCSEL 502 is driven by the LED/VCSEL driver 510 to emit IR radiation (e.g. towards a target for proximity sensing). The proximity IR photodiode 504 senses a reflected radiation from the proximity IR LED/VCSEL 502, for example, after it has been reflected from a target. The proximity analogue front end 514 generates a signal in response to the sensed radiation and the first ADC 524 converts this signal to a digital input to the digital controller 534. At a same or similar time, the ALS IR photodiode 506 senses the ambient IR radiation and the ALS analogue front end 516 generates a signal in response to the measured ambient radiation and the third ADC 526 converts this signal to a digital input to the digital controller 534. Thus, the digital controller 534 receives digital inputs representing the sensed reflected radiation (i.e. output from the first ADC 524) and the measured ambient radiation (i.e. from the third ADC 526).

The configuration registers 535 (i.e. memory 110) contain a plurality of ambient radiation level ranges and a plurality of coefficients that map onto the plurality of ambient radiation level ranges.

The digital controller 534 queries the configuration registers 535 to retrieve a coefficient selected from the plurality of coefficients (or a value derived from the plurality of coefficients) based on the measured ambient radiation level.

The digital controller 534 then compensates the output (i.e. from the first ADC 524) for crosstalk by subtracting from the output the measured ambient radiation level scaled by the coefficient selected from the plurality of coefficients (or the value derived from the plurality of coefficients). The digital controller 534 may then transmit the compensated output to another device (e.g. via the I2C interface 542 or may perform further processing based on the compensated output (e.g. to analyse the compensated output for proximity information and deactivate a display, for example).

It will be understood that the other components in the sensor package 552, for example, the clear filter photodiode 505, will be used in some embodiments but will not affect the functionality as described above in relation to the present disclosure. For example, the other components in the sensor package 552 may be operable to sense ambient visible radiation and control a brightness of the display (e.g. to deactivate the display).

FIG. 6 depicts an example of a flow-chart 600 of a proximity sensing calibration method, according to an embodiment of the disclosure.

In a first step 602, the processing circuitry 112 is configured to receive data in the form of a plurality of outputs from the radiation sensor 106. The plurality of outputs from the radiation sensor 106 correspond to sensing reflected radiation emitted from a radiation emitter 104, with the radiation sensor 106.

In a second step 604, the processing circuitry 112 is configured to receive data in the form of a plurality of ambient radiation levels. Each of the plurality of ambient radiation levels is measured at a time that substantially corresponds to a time of measurement of each of the plurality of outputs.

In a fourth step 606, the processing circuitry 112 is configured to determine a relationship between the plurality of outputs and the corresponding plurality of ambient radiation levels and to derive the plurality of coefficients based on the relationship. An example relationship is shown in FIG. 7 and described in more detail below.

The relationship may be based on, for example, linear interpolation, second or higher order interpolation, curve fitting, or a machine learning algorithm may be used.

Instead of interpolation, extrapolation may be used to determine a relationship between the outputs and the measured ambient radiation level.

The skilled person will understand that the steps 602, 604 and 606 may be performed in the order described above or other orders. The skilled person will also understand that some steps may be performed simultaneously or in parallel with other steps.

FIG. 7 depicts an example plot 700 of a plurality of outputs corresponding to a plurality of ambient radiation levels. The vertical axis corresponds to the outputs from the radiation sensor 106 and the horizontal axis corresponds to ambient radiation levels.

In the current embodiment, the relationship is based on a linear fit from one output point to the next (e.g. P1 to P2) thereby creating a series of corresponding ambient radiation level ranges (e.g. A1 to A2), each of which having a different linear relationship with an interpolated range of outputs. The specific outputs to use in determining this relationship may be selected to encompass a suitable range of ambient radiation levels for which a constant coefficient adequately compensates for crosstalk.

Each of the plurality of coefficients are derived by taking the gradient of each linear relationship (e.g. C1=(P2−P1)/(A2−A1)). Thus, depending on the measured ambient radiation level, a suitable coefficient (e.g. C1-C5) may be used to accurately reflect the amount of ambient radiation that could affect crosstalk in the proximity sensing device 100. As such, embodiments of this disclosure more accurately compensate for crosstalk at different levels of ambient radiation, when compared to prior art systems that employ the same coefficient regardless of the ambient radiation level.

The vertical dotted lines in the plot 700 denote defined ambient radiation ranges (e.g. between A1 and A2, etc.) for which a constant coefficient (e.g. C1, C2, etc.) may be used. However, each range only represents a subset of the possible ambient radiation levels and therefore a plurality of different coefficients are provided to map to different ambient radiation level ranges.

Measuring each of the plurality of ambient radiation levels at substantially the same time as measuring each of the plurality of outputs may not require that a measurement rate or time of the ambient radiation level and the output is identical. For example, the ambient radiation level may be measured every 100 ms and the output may be measured every 50 ms. In some embodiments, the time of measurement of the ambient radiation level may be offset from the time of measurement of the output.

Advantageously, the ambient radiation level may be measured within a time interval threshold of the output. For example, the threshold may be 10 ms, 100 ms, 1 s, 10 s.

The proximity sensing calibration method may compensate for ageing of the proximity sensing device.

The proximity sensing calibration method may be performed by a user or a manufacturer of the proximity sensing device. For example, the proximity sensing calibration method may be performed when the device is first manufactured and/or may be performed by a user either before or during use.

The proximity sensing calibration method may be invoked on receipt of a calibration instruction (e.g. from a user) or may be invoked automatically, for example, periodically.

In some embodiments, the proximity sensing calibration method may be invoked when a parameter is determined to fall outside of an acceptable range. For example, this could be when some or all of the plurality of coefficients no longer result in accurate compensation of the proximity sensing device for crosstalk.

Although the disclosure has been described in terms of particular embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

### LIST OF REFERENCE NUMERALS

100 proximity sensing device
104 radiation emitter
106 radiation sensor
108 ambient light sensor (ALS)
110 memory
112 processing circuitry
200 flow chart
202 first step
204 second step
206 third step
208 fourth step
300 cellular device
302 cellular device body
304 cellular device display
400 circuit
402 first stage operational amplifier (OPAMP)
403 second stage operational amplifier (OPAMP)
404 first ground
405 second ground
406 photodiode
408 first capacitor
409 second capacitor
410 third capacitor
412 variable resistor
414 variable poffset voltage
416 analogue to digital converter (ADC)
418 uncompensated output from the radiation sensor (pdata_{measured})
419 ambient light data (als_{ir_data})
422 coefficient/value (Cₓ)
424 compensator
426 compensated signal (pdata_{compensated})
500 schematic diagram
502 proximity IR LED/VCSEL
504 proximity IR photo diode
505 clear filter photo diode
506 ALS IR photo diode
508 supply voltage VDD3
510 LED/VCSEL driver
514 proximity analogue front end
515 clear filter analogue front end
516 ALS analogue front end
524 first analogue to digital converter (ADC)
525 second analogue to digital converter (ADC)
526 third analogue to digital converter (ADC)
534 digital controller
535 configuration registers
536 interrupt controller
538 ground (GND)
540 supply voltage VDD
542 I2C interface
544 serial data line SDA pad
545 serial clock line SCL pad
546 interrupt (INTR) pad
552 sensor package
554 sensor die
556 digital components
600 flow chart
602 first step
604 second step
606 third step
700 example plot

1. A proximity sensing device comprising:
a radiation emitter;
a radiation sensor configured to sense a reflected radiation from the radiation emitter;
a memory for storing a plurality of ambient radiation level ranges and a plurality of coefficients that map onto the plurality of ambient radiation level ranges; and
processing circuitry configured to compensate an output from the radiation sensor for crosstalk by subtracting from the output a measured ambient radiation level scaled by either:
a coefficient selected from the plurality of coefficients; or
a value derived from the plurality of coefficients, wherein the processing circuitry is configured to derive the value by performing on the plurality of coefficients at least one of:
linear interpolation,
second or higher order interpolation,
curve fitting, or
a machine learning algorithm.

2. The proximity sensing device of claim 1, comprising an ambient radiation sensor for obtaining the measured ambient radiation level.

3. The proximity sensing device of claim 1, wherein the processing circuitry is configured to select the coefficient from the plurality of coefficients using at least one of steps (a)-(c):
(a) comparing the measured ambient radiation level to the plurality of ambient radiation level ranges;
(b) selecting an ambient radiation level range that the measured ambient radiation level is within or closest to;
(c) selecting the coefficient from the plurality of coefficients that maps onto the ambient radiation level range that the measured ambient radiation level is within or closest to.

4. (canceled)

5. The proximity sensing device of claim 1, wherein the radiation is infrared light.

6. The proximity sensing device of claim 2, wherein the ambient radiation sensor includes an optical filter configured to only transmit a wavelength of the reflected radiation into the ambient radiation sensor.

7. The proximity sensing device of, claim 3, further comprising an ambient radiation sensor for obtaining the measured ambient radiation level, wherein the measured ambient radiation level is normalized for an integration time of the ambient radiation sensor.

8. The proximity sensing device of, claim 3, further comprising an ambient radiation sensor for obtaining the measured ambient radiation level, wherein the measured ambient radiation level is normalized for an analogue gain of the ambient radiation sensor.

9. A proximity sensing method comprising:
receiving an output of a radiation sensor, wherein the radiation sensor is configured to sense a reflected radiation from a radiation emitter;
receiving a measured ambient radiation level;
retrieving, based on the measured ambient radiation level, from a memory containing a plurality of ambient radiation level ranges and a plurality of coefficients that map onto the plurality of ambient radiation level ranges, a coefficient selected from the plurality of coefficients;
or a value derived from the plurality of coefficients by performing on the plurality of coefficients at least one of:
linear interpolation,
second or higher order interpolation,
curve fitting, or
a machine learning algorithm; and
compensating the output for crosstalk by subtracting from the output the measured ambient radiation level scaled by either:
the coefficient selected from the plurality of coefficients; or
the value derived from the plurality of coefficients.

10. The proximity sensing method of claim 9, comprising obtaining the measured ambient radiation level using an ambient radiation sensor.

11. The proximity sensing method of claim 9, comprising selecting the coefficient from the plurality of coefficients using at least one of steps (a)-(c):
(a) comparing the measured ambient radiation level to the plurality of ambient radiation level ranges;
(b) selecting an ambient radiation level range that the measured ambient radiation level is within or closest to;
(c) selecting the coefficient from the plurality of coefficients that maps onto the ambient radiation level range that the measured ambient radiation level is within or closest to.

12. (canceled)

13. The proximity sensing method of claim 9, wherein the radiation is infrared light.

14. The proximity sensing method of claim 11, further comprising obtaining the measured ambient radiation level using an ambient radiation sensor, and normalizing the measured ambient radiation level for an integration time of the ambient radiation sensor.

15. The proximity sensing method of claim 11, further comprising obtaining the measured ambient radiation level using an ambient radiation sensor, and normalizing the measured ambient radiation level for an analogue gain of the ambient radiation sensor.

16. A proximity sensing calibration method for determining a plurality of coefficients for use in compensating an output from a radiation sensor for crosstalk, the method comprising:
receiving a plurality of outputs from the radiation sensor, wherein the radiation sensor is configured to sense a reflected radiation from a radiation emitter;
receiving a plurality of ambient radiation levels, each of which is measured at a time that substantially corresponds to a time of measurement of each of the plurality of outputs; and
determining a relationship between the plurality of outputs and the corresponding plurality of ambient radiation levels and deriving the plurality of coefficients based on the relationship, wherein the relationship is determined using any one of:
a linear fit of the plurality of outputs at the corresponding ambient radiation levels;
a second or higher order fit of the plurality of outputs at the corresponding ambient radiation levels;
a curve fit of the plurality of outputs at the corresponding ambient radiation levels; or
a machine learning algorithm.

17. (canceled)

18. The proximity sensing calibration method of claim 16, wherein the plurality of coefficients are gradients based on the relationship of the plurality of outputs and the corresponding plurality of ambient radiation levels.

19. The proximity sensing method of claim 9, further comprising updating the plurality of coefficients by performing a proximity sensing calibration method including:
receiving a plurality of outputs from the radiation sensor;
receiving a plurality of ambient radiation levels, each of which is measured at a time that substantially corresponds to a time of measurement of each of the plurality of outputs; and
determining a relationship between the plurality of outputs and the corresponding plurality of ambient radiation levels and deriving the plurality of coefficients based on the relationship, wherein the relationship is determined using any one of:
a linear fit of the plurality of outputs at the corresponding ambient radiation levels;
a second or higher order fit of the plurality of outputs at the corresponding ambient radiation levels;
a curve fit of the plurality of outputs at the corresponding ambient radiation levels; or
a second machine learning algorithm.

20. A non-transitory computer readable storage medium comprising instructions which, when executed by processing circuitry cause the processing circuitry to perform the method of claim 9.

21. A device comprising the apparatus of claim 1 incorporated beneath a display screen.

22. Processing circuitry configured to carry out the method of claim 9.
